(19) United States
(12) Patent Application Publication
(10) Pub. No.: US 2025/0277938 A1
(43) Pub. Date: Sep. 4, 2025

(54) LENS MOUNT FOR LIGHT SCATTERING INSTRUMENT

(71) Applicant: Wyatt Technology, LLC, Goleta, CA (US)

(72) Inventors: Shivakumar Ramini, Newbury Park, CA (US); Siddharth Sood, Ventura, CA (US); Arunas Tuzikas, Lompoc, CA (US)

(21) Appl. No.: 19/068,434

(22) Filed: Mar. 3, 2025

Related U.S. Application Data
(60) Provisional application No. 63/560,264, filed on Mar. 1, 2024.

(51) Int. Cl. G02B 6/32

(52) U.S. Cl. CPC G02B 6/32

(57) ABSTRACT

An optical element mount assembly comprises a mount housing comprising an attachment clamp and a mount body; a flanged barrel assembly coupled and arranged to removably couple to the mount housing. The flanged barrel assembly comprises a lens barrel portion; and an alignment mount comprising a first flange and a second flange, each of the first and second flanges having a hole for receiving a coupling mechanism that attaches the flanged barrel assembly to a sidewall of the mount body, the flanged barrel assembly further comprising a mount hole for retaining an optical element.

### PRIORITY

This application claims priority to U.S. provisional patent application No. 63/560,264 filed Mar. 1, 2024 and titled “Lens Mount for Light Scattering Instrument,” the entirety of which is incorporated by reference herein.

### FIELD

The present concepts relate generally to a stress-free lens mount for improved light scattering performance in a fiber-based light scattering instrument.

### BACKGROUND

A scattering signal in a light scattering instrument is a function of the polarization of the light. For an accurate and repeatable measurements, it is necessary that the polarization state of the incident beam is close to linear and vertical polarization and stable over time, for example, shown in FIG. 2A.

When a polarized beam passes through an optical element, it can change the polarization state of the beam, referred to as birefringence. The polarization of an optical beam can be manipulated using birefringent materials. For example, rotating the polarization to specific orientation, converting from linear to elliptical polarization (shown in FIG. 2B), or separating the two orthogonal components (s and p polarization) into separate beams.

Some optical materials that are not usually birefringent exhibit birefringence when a mechanical stress is applied. This is referred to as stress-induced birefringence. When an optical beam passes through such optical materials under stress, it can distort the polarization of the beam. Since mechanical stress can change with temperature of the mechanical components, in effect, the polarization state of transmitted beam and light scattering signal thereafter becomes sensitive to and a function of the ambient temperature around the optical elements. This results in inferior measurement accuracy and repeatability.

FIGS. 1A-1D are views of an optical element mount assembly 100 that includes a conventional cylindrical-shaped lens barrel 108 that is held in place by an attachment clamp 106 that is constructed and arranged to rotate relative to a stationary lens mount body 107, which is configured to receive the clamp 106. In some embodiments, the attachment clamp 106 is a C-clamp that has a diameter or other interior dimension that is reduced when a torque is applied (shown by arrow) to the attachment clamp 106 by turning a screw 102, or bolt or the like having threads that cause the screw 102, bolt or the like to helically move toward a face of the attachment clamp 106, which in turn applies a force about some or all of the circumference of the lens barrel 108 to hold the lens barrel 108 in place in the clamp 106. In doing so, the articulated clamp 106 compresses to engage with the lens barrel 108. The amount of compression/engagement is dependent on the torque applied by the screw 102. During an operation, an optical beam is brought to the lens using a polarization-maintaining (PM) optical fiber 104. The beam passes through the lens in the lens barrel 108 to a sample cell or other chromatography component where the beam focuses to a spot at a distance where the test sample is situated for light scattering measurements.

When the torque is low, i.e., the force applied by the screw 102 against the attachment clamp 106 polarization of the transmitted beam through the focusing lens has nearly vertically polarization, shown in FIG. 2A, which illustrates a displayed line 201 aligned to the vertical axis. The line 201 is generated by a well-known instrument. Here, the screw 102 may be referred to as “loose”. When the torque is high, i.e., or the screw 102 is sufficiently “tight” to mechanically secure the barrel 108 in place in the attachment clamp 106, polarization of the transmitted beam becomes elliptical 202 and rotated by 15 degrees with respect to the vertical axis, shown in FIG. 2B.

Corresponding light scattering data is shown as a plot in FIG. 9. Stability of the signal in response to change in system temperature is monitored by alternating the environmental temperature between 20° C. and 25° C. for a duration of 2 hours at each temperature setpoint. In this example, in response to change in the environment temperature, a system temperature inside the instrument ranges from 33-39 degrees C. (plot 901 in FIG. 9). Plotted on the left side of the graph 900 in FIG. 9 is a normalized light scattering intensity signal denoted by a ratio of a light scattering signal (LS) to a laser monitor (LM). The signal is normalized to the overall optical power (laser monitor, LM) to subtract the effect of change in the incident optical power. ‘Loose barrel’ configuration (see plot 902) is when no torque is applied by the screw 102 to the attachment clamp 106 (see also polarization in FIG. 2A) but will lack mechanical stability since the screw is required so that the C-clamp can apply a force about the lens. Also shown in the graph 900 in FIG. 9 is a ‘tight barrel’ configuration (see plot 903) is when torque is applied by the screw 102 to fully secure the clamp 106 in the lens mount body 207 so that the clamp 106 is likewise stationary to be mechanically stable (see also polarization in FIG. 2B).

Absolute value of the LS/LM is used to calibrate the system. A stability of the signal (referred to as a “MinMax”) is calculated as the difference between maximum and minimum values divided by the average of the signal, this directly related to the accuracy and repeatability of the measurements over time. During an experiment, results of which are shown in FIG. 9, the ‘tight barrel’ configuration resulted in 4.8% variation depending on the temperature, for example, oscillating between 0.027 and 0.028, blue plot in FIG. 9, while a ‘loose barrel’ configuration resulted in a much lower change, 1.8% oscillating between 0.0235 and 0.024 plot 902 in FIG. 9. Spikes in the plt 902 result from cleanliness issues of the sample and are ignored when calculating the MinMax percentage. Difference in absolute value is due to slight variation in the detector alignment in two configurations.

In the conventional apparatus shown in FIGS. 1A-1D, when sufficient stress is applied to the focusing lens by the clamp 106 depending on the applied torque, a polarization of the transmitted beam is distorted due to stress-induced birefringence, as shown in FIG. 2B. Since the mechanical stress changes with temperature of the mount, a polarization of the transmitted beam becomes very sensitive to the temperature and in turn results in light scattering signal changing with temperature much more compared to loose (no-stress) configuration.

It is desirable for a lens mount that securely holds the lens in a manner that ensures that the optical properties remain consistent across all operational temperature ranges, which would prevent the introduction of birefringence in the lens that would otherwise be induced by a C-clamp holding the focusing mount as shown in FIGS. 1A-1D, and, consequently, maintain the polarization state of a transmitted beam of light unchanged.

### SUMMARY

In one aspect, an optical element mount assembly comprises a mount housing comprising an attachment clamp and a mount body; a flanged barrel assembly coupled and arranged to removably couple to the mount housing. The flanged barrel assembly comprises a lens barrel portion; and an alignment mount comprising a first flange and a second flange, each of the first and second flanges having a hole for receiving a coupling mechanism that attaches the flanged barrel assembly to a sidewall of the mount body, the flanged barrel assembly further comprising a mount hole for retaining an optical element.

In another aspect, an optical element mount assembly comprises a lens barrel portion for holding a lens; a flanged portion integral with the lens barrel portion; a first region of the flanged portion having a first hole for receiving a first coupling element; and a second region of the flanged portion having a second hole for receiving a second coupling element, wherein the lens barrel portion is constructed and arranged for insertion into a C-clamp and the flanged portion is coupled to a sidewall of the C-clamp by the first and second coupling elements.

In another aspect, a fiber-based light scattering instrument comprises a lens; an alignment mount; a flanged barrel comprising at least two holes to receive at least two screws to attach the flanged barrel to the alignment mount, wherein the lens is positioned in a distal end of the flanged barrel; a fiberoptic assembly at a proximal end of the flanged barrel and that is aligned with the lens; and a cell for holding a material sample a predetermined distance from the lens, the fiberoptic assembly outputting a beam of light through the lens to the cell.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1A is an exploded view of a conventional optical element mount assembly for a fiber-based light scattering instrument.

FIG. 1B is an assembled view of the conventional optical element mount assembly of FIG. 1A.=

FIGS. 1C and 1D are side views of the conventional optical element mount assembly of FIG. 1A and 1B.

FIG. 2A is a view of a plot of a vertical polarization of a transmitted beam through a focusing lens positioned to a optical element mount assembly.

FIG. 2B is a view of a plot of a polarization of a transmitted beam rotated by 15 degrees with respect to vertical due to a high torque applied by the screw to the C-clamp shown in FIGS. 1A and 1B.

FIG. 3A is an exploded view of a flanged lens mount of a optical element mount assembly for a fiber-based light scattering instrument, in accordance with an exemplary embodiment.

FIG. 3B is an assembled view of the optical element mount assembly of FIG. 3A.

FIG. 3C is a side view of the optical element mount assembly of FIGS. 3A and 3B.

FIG. 4 is a perspective view of the flanged optical element mount assembly of FIGS. 3A and 3B.

FIG. 5 is a close-up perspective view of the optical element mount assembly of FIG. 3B.

FIGS. 6A and 7 are other perspective views of the flanged optical element mount assembly of FIGS. 3A-5.

FIG. 6B is a perspective view of a fiber assembly and coupler.

FIGS. 8A-8B are front and side views of test data illustrating a lens mount under stress during operation.

FIG. 9 is a graphical representation of a comparison between light scattering data results produced during a comparison between the optical element mount assembly of FIGS. 1A and 1B and the optical element mount assembly of FIGS. 3A and 3B.

FIGS. 10-12 are additional views of the optical element mount assembly of FIGS. 3A and 3B, in accordance with some embodiments.

FIG. 13 is a view of an optical element mount assembly outputting a laser beam to a cell, in accordance with some embodiments.

### DETAILED DESCRIPTION

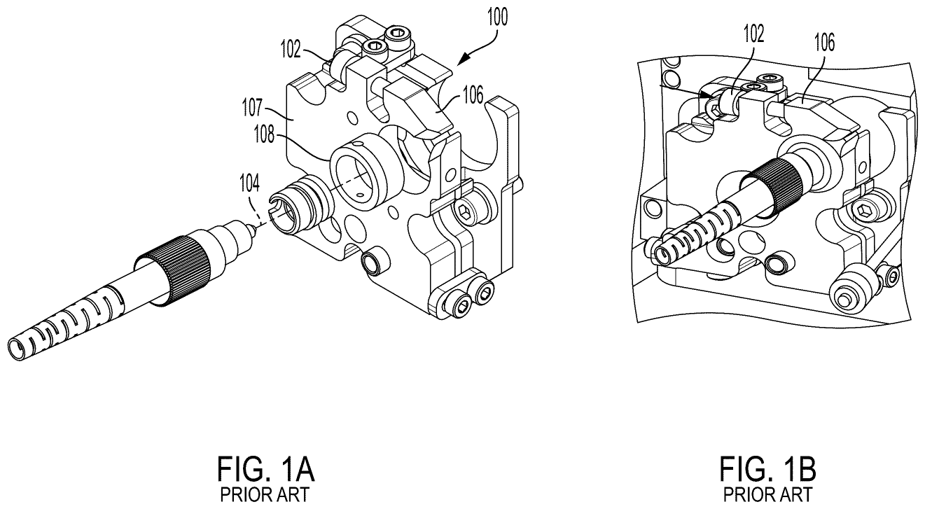

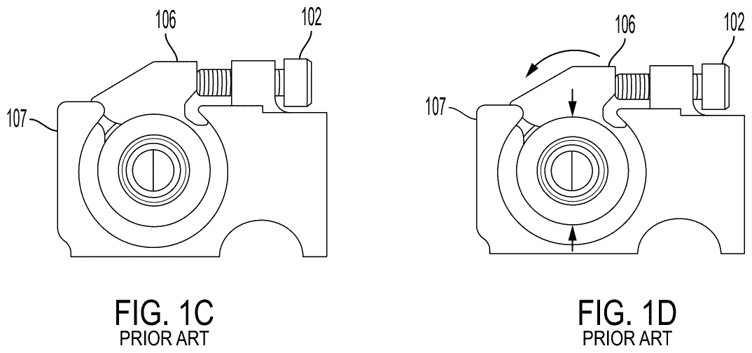

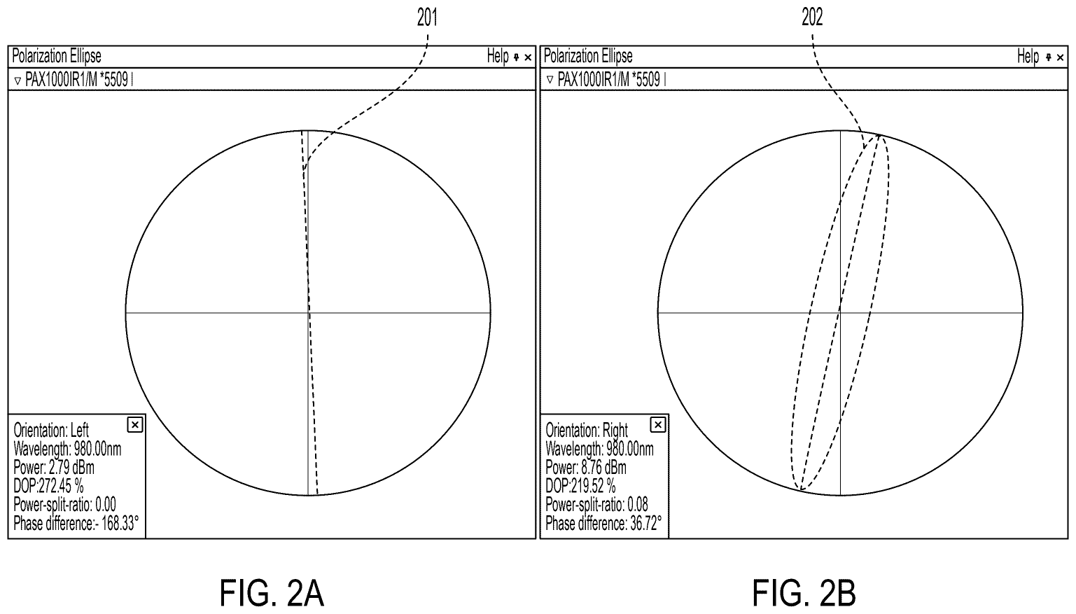

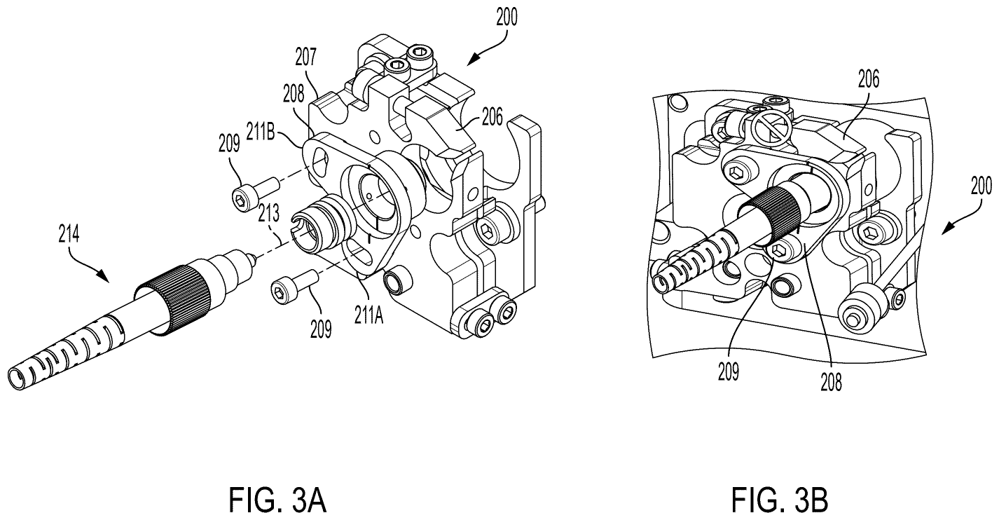

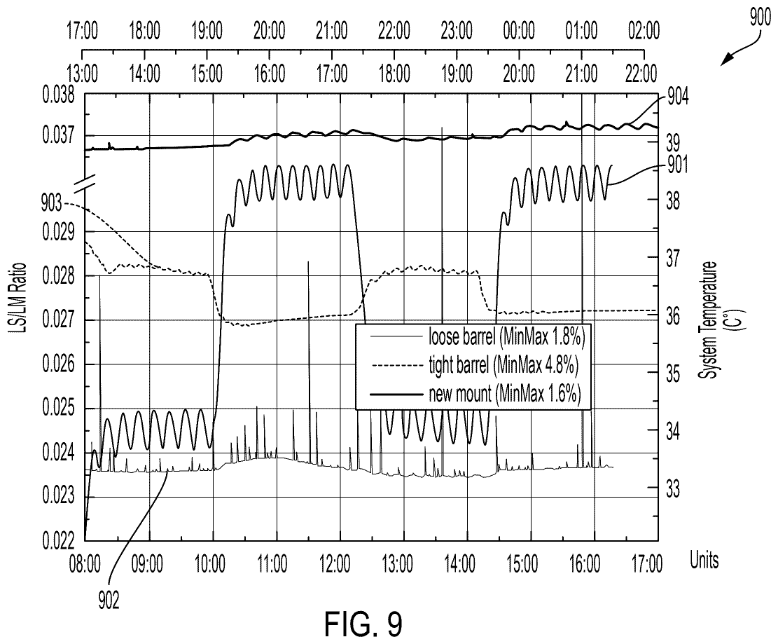

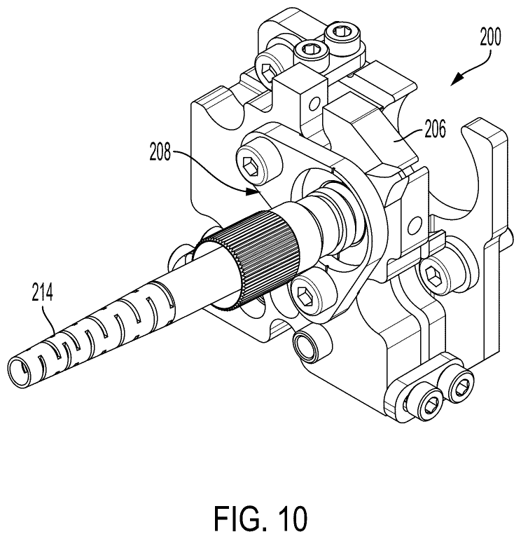

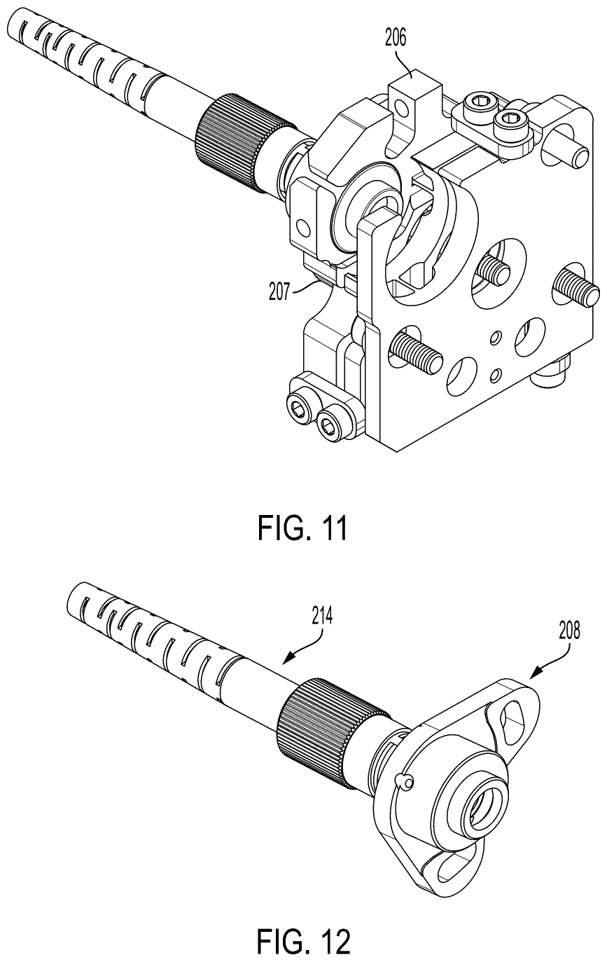

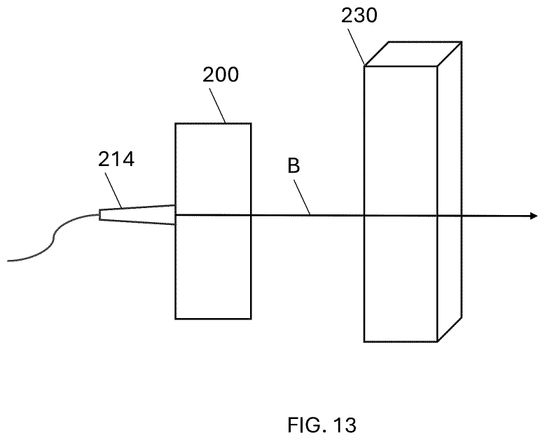

FIGS. 3A-7, and 10-12, and 14 illustrate a optical element mount assembly 200 in accordance with embodiments of the present inventive concept. The optical element mount assembly 200 includes a flanged barrel assembly 208 comprising a flanged alignment mount 205 and a lens barrel portion 210, in accordance with embodiments of the present inventive concept. As shown in particular at FIG. 4, the flanged barrel assembly 208 includes a lens barrel portion 210 and two flanged portions 211A, 211B (generally, 211) extending from a proximal end 217 of the lens barrel portion 210. A distal portion 215 extends from the clamp 206, which is positioned about the main body of the lens barrel portion 210. The distal portion 215 allows the lens to protrude to a desirable and predetermined distance from the sample cell, e.g., cell 230 shown in FIG. 13, for proper focusing. The clamp 206 in turn is positioned in a lens mount body 207 and can rotate inside the lens mount body 207 in the absence of a force provided by a securing element such as the screw 102 in FIGS. 1A-1D or preferably the flanged barrel assembly 208. Accordingly, the clamp 206 and lens mount body 207 may be similar to or the same as the clamp 106 and lens mount body 107 of FIGS. 1A-1D except for threaded holes or the like extending through a sidewall of the lens mount body 207 for coupling the flanged barrel assembly 208. The clamp 206 and lens mount body 207 can collectively be referred to as a mount housing.

In some embodiments the alignment mount 205 and lens barrel portion 210 of the flanged barrel assembly 208 may be machined from a common stock of metal or composite or the like and therefore integral, or the alignment mount 205 and lens barrel portion 210 may be formed separately and coupled together by adhesive, weld, or other coupling technique or mechanism. An interface of the proximal end of the barrel portion 210 and the alignment mount 205 includes a mount hole 216 (see FIG. 4) centered in the barrel assembly 208 that is constructed and arranged for holding an optical element such as a lens 203, which is inserted in the central hole 216 in the alignment mount 205 for positioning in the optical element mount assembly 200, which in turn is coupled to the lens mount body 207. Accordingly, the flanged barrel assembly 208 can attach to the mount body 207. The mount hole 216 may have a first diameter at the alignment mount and a second diameter less than the first diameter extending through the barrel portion 210. The flanges 211 of the alignment mount 205 are constructed and arranged to couple to the sidewall of the mount housing 206 to retain an optical element, for example, lens 203, thereby enabling stable light scattering measurements.

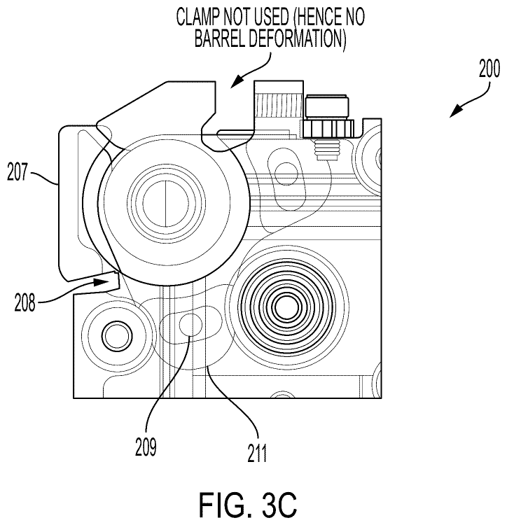

However, unlike a conventional clamp 106 shown in FIGS. 1A-1D, a torque or related force for closing the clamp is not required (see FIG. 3C as compared to the conventional mount shown in FIGS. 1C and 1D), since the bolts 209 or screws or other related coupling mechanisms are inserted through holes 212 in the flanged portions 211 of the alignment mount 205 of the flanged barrel assembly 208 for coupling to a sidewall of the mount housing 206 as shown in FIG. 5. The alignment mount 205 may also be referred to as a flex mount or kinematic stage.

The holes 212 may be shaped as slots may not be circular, but of a different shape. Since the barrel assembly 208 is face mounted using the two bolts 209 or screws instead of the c-clamp, mechanical stress on the lens in the barrel assembly 208 is essentially or entirely eliminated.

The flanged barrel assembly 208 is concentric with the fiber, lens and mount housing 206 and in doing so allows fine adjustment of the polarization angle relative to the sample. The lens barrel portion 210 protrudes from the main body of the lens barrel portion 210 for insertion into the center opening 107 of the conventional clamp 106, but does not rely on the screw 102 for closing the clamp 106 about the lens barrel portion 210 since the bolts 209 or screws or other related coupling elements are inserted through the holes 212 in the flanged portions 211 of the flanged barrel assembly 208 for coupling to a sidewall of the mount housing 206. The flanged lens barrel assembly 208, in conjunction with the mount housing 206 that permits the attachment at the sidewalls of the housing 206, facilitates the precise positioning of the optical beam relative to the sample, offering degrees of freedom in the x, y, pitch, yaw, and angular directions. In other words, the flanged barrel 210 is concentric with the lens 203, the barrel assembly 208 and lens 203 are in desired positions allowing the optical fiber (not shown) to be adjusted within the barrel assembly 208, i.e., x, y, pitch, yaw, angular positions.

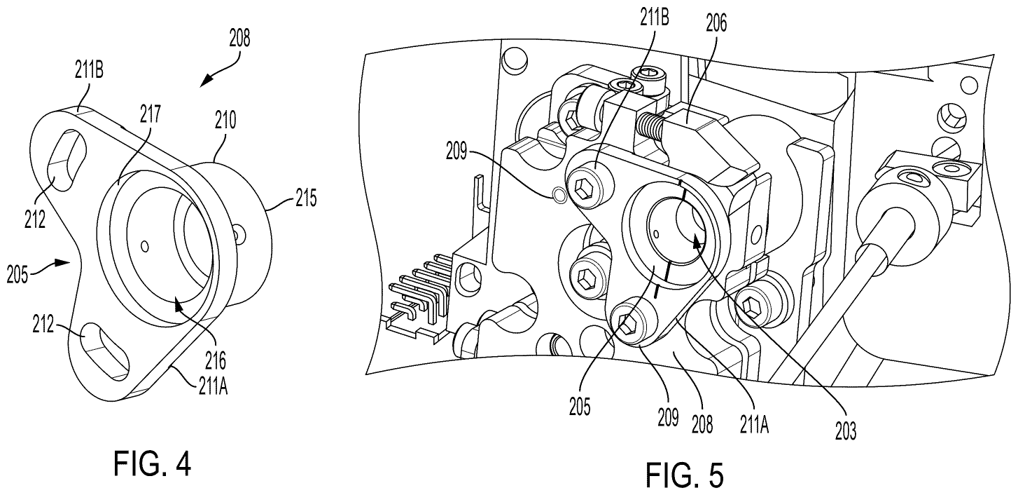

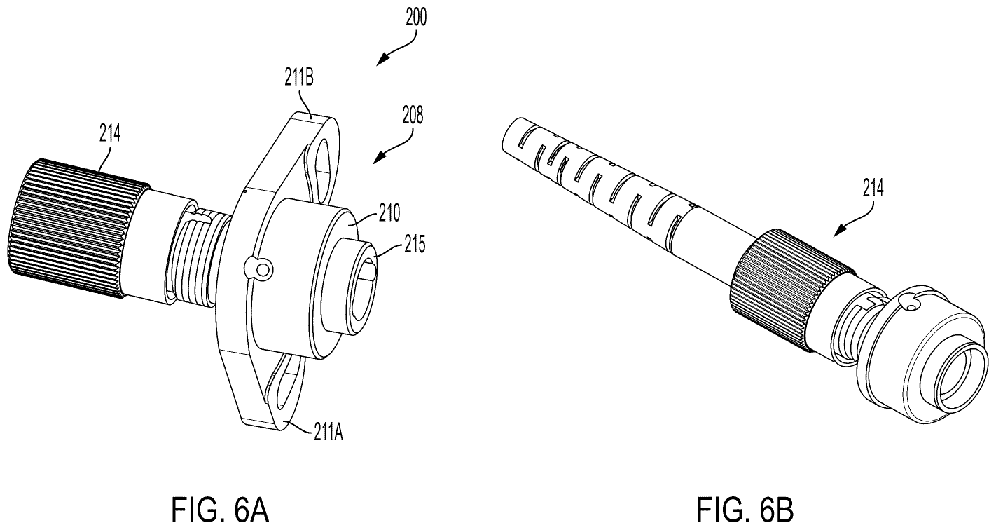

FIGS. 6A and 7 illustrate perspective views of the optical element mount assembly 200. As shown, the flanged barrel assembly 208 has a proximal portion 217 that is opposite the distal portion 215 and concentric with the lens barrel portion 210 and the distal portion 215, and is constructed to extend from the lens barrel portion 210 to engage and mate with a fiber assembly 214, or fiber connector. In some embodiments, the distal portion 215 is compliantly inserted into a cylindrical foam element used for preventing dust or other undesirable particles from the optical element, e.g., lens. The distal end 215 of lens barrel portion 210 may extend from the lens barrel bore extending through a center of the flanged barrel assembly. The bore may have an outer diameter less than an outer diameter of the lens barrel portion. The distal end 215 may have a smaller diameter for insertion into the cylindrical foam element. In some embodiments, the fiber assembly 214 (shown in FIG. 6B) can be coupled to the proximal end 217 having an opening to the mount region 216 where the optical element, e.g., lens, is mounted. Here, lens barrel portion of the flanged barrel assembly is concentric with the optical element, and configured to position the barrel and lens in a desired position and allow to adjust fiber within the barrel, e.g., x, y, pitch, yaw, angular, and so on. In some embodiments, the fiber assembly 214 includes fiber with a knurl screw used to connect it to a coupler. When assembled. an optical beam is brought to the lens using a optical fiber (not shown) extending through and terminating at the fiber assembly 214. As shown in FIG. 13, the beam (B) passes through the lens in the optical element mount assembly 200 to a sample cell 230 or other chromatography component where the beam focuses to a spot at a distance where the test sample is situated for light scattering measurements. The cell 230 can hold a material sample a predetermined distance from the lens, and the fiberoptic assembly 214 outputting a beam of light through the lens to the cell 230.

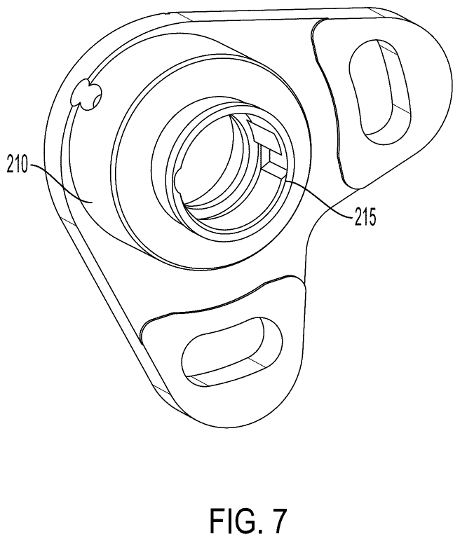

The flanged barrel assembly 208 avoids unnecessary mechanical stresses on the lens in the optical element mount assembly 200 while also mechanically stable. This has following advantages. Since the barrel assembly 208 is face mounted using the abovementioned two bolts or screws 209 parallel to the direction of extension of the fiber assembly 214 instead of a bolt extending perpendicular to the C-clamp (shown in FIGS. 1C-1D), mechanical stress on the lens in the barrel is practically eliminated. Having slotted screw holes extending through the face of the mount housing 206 provides some rotational freedom that allows adjusting the orientation of the beam polarization if required. As shown in the comparative drawings in FIGS. 1A-1D and 3A-3C and the test data plots shown in FIGS. 8A and 8B, the optical element mount assembly 200 does not cause barrel deformation since, unlike the conventional lens mount, a clamp including a bolt 102 is not used or required.

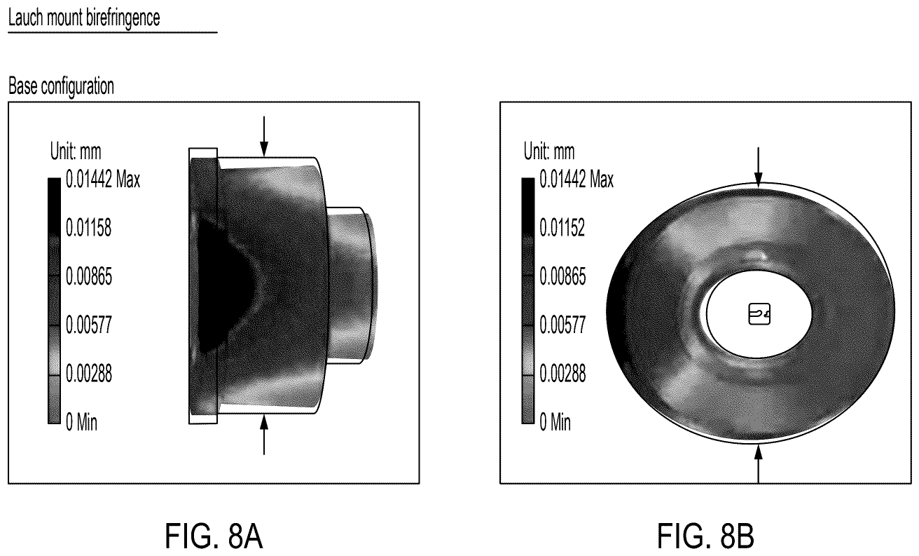

Light scattering data is collected using the lens barrel assembly 208 that is firmly secured to the mount 206 and shown in the plot 904 in the graph illustrated in FIG. 9, which shows an improved percentage change (MinMax 1.6%) as compared to a a loose barrel (MinMax 1.8%) or tight barrel (MinMax 4.8%) described above with respect to FIGS. 1A and 1B. Change in the normalized light scattering signal (LS/LM) is comparable with a loose barrel configuration, e.g., shown in the plot 901 in FIG. 9. This demonstrates that the polarization state did not appreciably change with the system temperature change as intended. The experiment is repeated in multiple instruments and the results are repeatable.

The flanged barrel assembly 208 achieves the desired linear polarization of a beam from the fiber 213 extending from a launch mount (see also FIG. 1), the bean transmitted through the lens (see FIG. 3B) while also providing the necessary mechanical stabilization that cannot be offered by a torque screw based configuration shown in FIGS. 1A-1E.

As also shown in the graphical view of FIG. 9, the flanged barrel assembly 208 can also accommodate for mechanical stress, which can change with temperature of the mechanical components. This provides stability of a normalized SLS (denoted by LS/LM) as a function of system temperature of the instrument. Shown is a stable signal (plot 904) in response to changes in system temperature even though polarization of the transmitted beam may become sensitive to the temperature.

What is claimed is:

1. An optical element mount assembly, comprising:
a mount housing comprising an attachment clamp and a mount body;
a flanged barrel assembly coupled and arranged to removably couple to the mount housing, the flanged barrel assembly comprising:
a lens barrel portion; and
an alignment mount comprising a first flange and a second flange, each of the first and second flanges having a hole for receiving a coupling mechanism that attaches the flanged barrel assembly to a sidewall of the mount body, the flanged barrel assembly further comprising a mount hole for retaining an optical element.

2. The optical element mount assembly of claim 1, wherein the attachment clamp includes a C-clamp.

3. The optical element mount assembly of claim 1, wherein the optical element includes a lens.

4. The optical element mount assembly of claim 1, wherein the coupling mechanisms are bolts inserted through the holes of the first and second flanges and are parallel to a direction of extension of a fiber assembly coupled to the flanged barrel assembly.

5. The optical element mount assembly of claim 4, wherein the alignment mount is face mounted to the mount housing so that the lens barrel portion is secured inside the attachment clamp by the bolts threaded into holes in the sidewall of the mount body.

6. The optical element mount assembly of claim 1, wherein the holes in the first and second flange are slotted to allow adjusting an orientation of a beam polarization generated by a fiber of a fiber assembly coupled the alignment mount.

7. The optical element mount assembly of claim 1, wherein the lens barrel portion has a distal end extending from a lens barrel bore extending through a center of the flanged barrel assembly, the lens barrel bore having a first outer diameter less than an outer diameter of the lens barrel portion.

8. The optical element mount assembly of claim 7, wherein the distal end has a first inner diameter, the lens barrel portion has a second inner diameter greater than the first inner diameter, and the alignment mount having a third inner diameter greater than the second inner diameter, wherein the third inner diameter is constructed and arranged to couple to a fiber assembly.

9. The optical element mount assembly of claim 8, wherein the distal end is a predetermined distance from a cell holding a material sample, and wherein the fiber assembly includes a fiber that outputs a beam of light through the lens to the cell.

10. A optical element mount assembly, comprising:
a lens barrel portion for holding a lens;
a flanged portion integral with the lens barrel portion;
a first region of the flanged portion having a first hole for receiving a first coupling element; and
a second region of the flanged portion having a second hole for receiving a second coupling element, wherein the lens barrel portion is constructed and arranged for insertion into a C-clamp and the flanged portion is coupled to a sidewall of the C-clamp by the first and second coupling elements.

11. The optical element mount assembly of claim 10, further comprising the coupling mechanisms, wherein the coupling mechanisms are bolts inserted through the holes of the first and second flanges and are parallel to a direction of extension of a fiber assembly coupled to the flanged portion.

12. The optical element mount assembly of claim 11, wherein the holes in the first and second regions of the flanged portion have holes or slots to allow adjusting an orientation of a beam polarization generated by a fiber of a fiber assembly.

13. The optical element mount assembly of claim 11, wherein the lens barrel portion has a distal end extending from a lens barrel bore extending through a center of the flanged portion, the bore having a first outer diameter less than an outer diameter of the lens barrel portion.

14. The optical element mount assembly of claim 13, wherein the distal end has a first inner diameter, the lens barrel portion has a second inner diameter greater than the first inner diameter, and the alignment mount having a third inner diameter greater than the second inner diameter, wherein the third inner diameter is constructed and arranged to couple to the fiber assembly.

15. The optical element mount assembly of claim 13, wherein the distal end is a predetermined distance from a cell holding a material sample, and wherein the includes a fiber that outputs a beam of light through the lens to a cell.

16. A fiber-based light scattering instrument, comprising:
a lens;
an alignment mount;
a flanged barrel comprising at least two holes to receive at least two screws to attach the flanged barrel to the alignment mount, wherein the lens is positioned in a distal end of the flanged barrel; and
a fiberoptic assembly at a proximal end of the flanged barrel and that is aligned with the lens; and
a cell for holding a material sample a predetermined distance from the lens, the fiberoptic assembly outputting a beam of light through the lens to the cell.

17. The fiber-based light scattering instrument of claim 16, further comprising coupling mechanisms inserted through the holes of first and second flanges of the flanged barrel assembly and are parallel to a direction of extension of a fiber assembly coupled to the flanged barrel.

18. The fiber-based light scattering instrument of claim 16, wherein the holes have slots to allow adjusting an orientation of a beam polarization generated by a fiber of a fiber assembly.

19. The fiber-based light scattering instrument of claim 16, wherein the flanged barrel has a distal end extending from a lens barrel bore extending through a center of the flanged barrel, the bore having a first outer diameter less than an outer diameter of the lens.

20. The fiber-based light scattering instrument of claim 19, wherein the distal end has a first inner diameter, the lens barrel portion has a second inner diameter greater than the first inner diameter, and the alignment mount having a third inner diameter greater than the second inner diameter, wherein the third inner diameter is constructed and arranged to couple to the fiberoptic assembly.
